(19) United States
(12) Patent Application Publication
(10) Pub. No.: US 2026/0112289 A1
(43) Pub. Date: Apr. 23, 2026

(54) SYSTEM AND METHOD FOR READING DEVELOPMENT USING WORD-TO-GRAPHIC TRANSFORMATIONS

(71) Applicant: Kevin Ma, Bentonville, AR (US)

(72) Inventor: Kevin Ma, Bentonville, AR (US)

(21) Appl. No.: 19/091,104

(22) Filed: Mar. 26, 2025

Related U.S. Application Data
(60) Provisional application No. 63/710,267, filed on Oct. 22, 2024.

(51) Int. Cl. G09B 17/00; G06T 13/80; G09B 5/06; G09B 7/04

(52) U.S. Cl. CPC G09B 17/00; G06T 13/80; G09B 5/06; G09B 7/04

(57) ABSTRACT

A system and method for reading development in children with dyslexia using word-to-graphic transformations are disclosed. The method includes presenting words to the learner and converting the words into corresponding graphical representations that visually depict the meaning of the words. The method further includes associating phonemes with parts of the graphical representation to help the learner connect speech sounds with written letters. Next, the method includes progressively simplifying the graphical representation of words as the learner's reading proficiency improves, transitioning them toward recognizing standard written words. The method also includes tracking the learner's progress through a proficiency tracking module, which dynamically adjusts the complexity of future word transformations based on performance data. Additionally, the method provides real-time auditory and visual feedback during the learning process to reinforce phoneme-grapheme associations. The system operates on an interactive platform, such as a tablet, allowing personalized learning experiences based on the child's individual progress.

### CROSS-REFERENCE TO RELATED APPLICATIONS

The present application claims benefit of U.S. Provisional Application No. 63/710,267, filed Oct. 22, 2024; all of which is incorporated herein in its entirety and referenced thereto.

### BACKGROUND OF THE INVENTION

### Field of the Invention

The present invention relates to reading development systems. Specifically, the present invention relates to a system and method designed to improve reading proficiency in children with dyslexia. The present invention uses word-to-graphic transformations to help learners associate phonemes with written letters.

### Description of the Prior Art

Reading development systems are essential tools used in educational settings to support children in learning how to read. Such systems are particularly valuable for children with dyslexia, who face unique challenges in connecting speech sounds with their corresponding letters. Existing systems provide a range of teaching methods, including phonetic and visual learning techniques, aimed at improving literacy.

Current reading development solutions include phonetic-based learning, visual aids, and interactive learning platforms. For instance, US Patent Application US 20100184009A1 discloses methods for teaching sound-symbol relationships, with emphasis on phoneme-level learning. Another US Patent Application, US 20230377476A1, provides personalized reading assistance using visual modifications such as bold text or emojis to aid reading comprehension. Additionally, U.S. Pat. No. 11,775,735B2 discloses a system that animates individual letters to associate phonemes with visual elements, such as a pig icon for the letter “p,” focusing primarily on phoneme-level teaching. These solutions offer various approaches to help dyslexic children connect sounds with letters.

However, existing systems fall short in creating a holistic connection between entire words and their meanings. Many solutions focus on phonemes rather than whole words, which may limit comprehension for children with dyslexia. For example, the method disclosed in U.S. Pat. No. 11,775,735B2 focuses on the phoneme level without directly linking the pictorial representation to the word's meaning. Similarly, other systems rely heavily on phonetic cues, which may not fully utilize the visual-spatial reasoning strengths often observed in children with dyslexia.

Moreover, current systems lack a progressive learning approach that simplifies the visual representation as the child's reading proficiency increases. The absence of a seamless transition from graphical representation to the standard written form of words hinders the learner's progression towards independent reading. Furthermore, the reliance on phonetic symbols and abstract visual modifications, such as emojis, does not adequately bridge the gap between word recognition and comprehension.

Therefore, there is a need for a reading development system that transforms entire words into graphical representations that directly correspond to the word's meaning. Such a system should provide a progressive learning pathway that gradually reduces the graphical complexity as the learner's reading proficiency improves, ultimately supporting children with dyslexia in developing both phoneme-grapheme associations and word recognition skills.

The information disclosed in this background section is solely for the enhancement of understanding of the general background of the disclosure and is not intended to be an acknowledgment that any part of this information forms prior art.

### SUMMARY OF THE INVENTION

An object of the present disclosure is to provide a system and method (together termed as “mechanism”) for facilitating reading development in children with dyslexia by transforming words into graphical representations. The mechanism is designed to help children make connections between speech sounds and written letters using visual-spatial reasoning strengths. The mechanism progressively simplifies the graphical representations as the learner's reading proficiency improves, bridging the gap between visual and textual learning.

In operation, when a child is presented with a word, the mechanism transforms the word into a corresponding graphic that visually represents the object or event the word refers to. For example, the word “cat” may be depicted as an image of a cat, where each letter is a component of the image. As a missing piece in the graphic string disrupts the wholeness of the object, this helps children recognize the connection between each phoneme (sound) and its corresponding letter. The transformation module manages the creation of this graphical representation and the association of phonemes with their corresponding letters. As the child's proficiency improves, the system simplifies the graphical representation, gradually transitioning the learner towards recognizing the standard written word.

In an embodiment, the system includes an auditory feedback component that synchronizes with the graphical transformation to reinforce the association between phonemes and graphemes. This component produces auditory cues for each phoneme as the word's corresponding graphic is displayed. The system also stores progress data for each learner, allowing for dynamic adjustments to future word-to-graphic transformations based on individual learning metrics.

An embodiment of the present disclosure discloses the system for reading development in children with dyslexia using word-to-graphic transformations. The system includes a transformation module that converts words into graphical representations and progressively reduces the graphical complexity as the learner improves. The system also includes a proficiency tracking module to monitor the learner's progress and adjust the complexity of the graphical representations dynamically. Additionally, the system includes a feedback module that provides real-time auditory and visual feedback during the learning process, helping the learner associate letters with their corresponding sounds.

The system further includes a data storage unit to store various types of data required for its operation. This includes graphical transformation data and learner progress data. The system can be implemented on a server, and data communication within the system may occur over a secure network, enabling communication between the system, the learner, and the teacher or facilitator.

An embodiment of the present disclosure discloses a method for facilitating reading development in children with dyslexia using word-to-graphic transformations. The method includes the steps of presenting a word to the learner and transforming it into a graphical representation that visually conveys its meaning. The method further includes associating the phonemes of the word with corresponding parts of the graphical representation.

The method also includes the step of progressively reducing the complexity of the graphical representation as the learner's reading proficiency improves. Additionally, the method includes tracking the learner's progress using a proficiency tracking module, dynamically adjusting the complexity of future graphical transformations based on the learner's progress data.

Next, the method includes the step of providing real-time auditory and visual feedback during the learning process to reinforce the learner's understanding of phoneme-grapheme associations. The method ends with the learner transitioning from reliance on graphical representations to recognizing the standard written word without the need for visual aids.

These and other objects of the present invention will be apparent from the following specification and the accompanying drawings.

### BRIEF DESCRIPTION OF THE DRAWINGS

FIG. 1 is an exemplary environment of a system for reading development in children with dyslexia using word-to-graphic transformations, in accordance with an embodiment of the present disclosure.

FIG. 2 illustrates a system for reading development using graphical word transformation, in accordance with an embodiment of the present disclosure.

FIG. 3 is a flowchart illustrating a method for reading development using graphical word transformation, in accordance with an embodiment of the present disclosure.

FIG. 4, FIG. 5, and FIG. 6 illustrate application of the system and method for reading development using graphical word transformation, in accordance with an embodiment of the present disclosure.

FIG. 7 is an exemplary computer unit in which or with which embodiments of the present disclosure may be utilized.

FIGS. 8A, 8B, and 8C illustrate first-stage, second-stage, and third-stage physical flashcards for the word “Bottle,” in accordance with an embodiment of the present disclosure.

FIGS. 9A, 9B, and 9C illustrate first-stage, second-stage, and third-stage physical flashcards for the word “Hammer,” in accordance with an embodiment of the present disclosure.

### DETAILED DESCRIPTION OF THE PREFERRED EMBODIMENT

The detailed description set forth below in connection with the appended drawings is intended as a description of exemplary embodiments in which the presently disclosed disclosure can be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed disclosure. However, it will be apparent to those skilled in the art that the presently disclosed disclosure may be practiced without these specific details. In some instances, well-known structures and devices are shown in block diagram form in order to avoid obscuring the concepts of the presently disclosed disclosure.

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, and/or firmware.

Embodiments of the present disclosure may be provided as a computer program product, which may include a non-transitory, machine-readable storage medium tangibly embodying thereon instructions, which may be used to program the computer (or other electronic devices) to perform a process. The machine-readable medium may include, but is not limited to, fixed (hard) drives, semiconductor memories, such as Read Only Memories (ROMs), Programmable Read-Only Memories (PROMs), Random Access Memories (RAMs), Erasable PROMs (EPROMs), Electrically Erasable PROMs (EEPROMs), flash memory or other types of media/machine-readable medium suitable for storing electronic instructions (e.g., computer programming code, such as software or firmware).

Various methods described herein may be practiced by combining one or more non-transitory, machine-readable storage media containing the code according to the present disclosure with appropriate standard computer hardware to execute the code contained therein. An apparatus for practicing various embodiments of the present disclosure may involve one or more computers (or one or more processors within the single computer) and storage systems containing or having network access to a computer program(s) coded in accordance with various methods described herein, and the method steps of the disclosure could be accomplished by modules, routines, subroutines, or subparts of a computer program product.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed therebetween, while not sharing any physical connection. Based on the disclosure provided herein, one of ordinary skill in the art will appreciate a variety of ways in which connection or coupling exists in accordance with the definition.

Further, the term “module” may be software or hardware particularly programmed to receive an input, perform one or more processes using the input, and provide an output. The input, output, and processes performed by various modules will be apparent to one skilled in the art based on the present disclosure.

If the specification states a component or feature “may,” “can,” “could,” or “might” be included or have a characteristic, that particular component or feature is not required to be included or have the characteristic.

As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

It will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular name.

Embodiments of the present disclosure relate to a system and method (together termed as “mechanism”) for facilitating reading development in children with dyslexia by transforming words into graphics. The mechanism is designed to help children with dyslexia make connections between speech sounds and written letters by using visual-spatial reasoning strengths. The mechanism operates by progressively simplifying the graphical representations of words as learners' reading proficiency improves, thus bridging the gap between the graphical representation and the written word.

In operation, when a child is presented with a word to read, the mechanism may first transform the word into a corresponding graphic that visually represents the meaning of the word. For example, the word “cat” may be depicted as an image of a cat, where each letter in the word is represented as a component of the image. The mechanism may allow the child to visually comprehend the word's meaning while simultaneously associating each phoneme with its corresponding letter. As the child's proficiency advances, the complexity of the graphical representation may be reduced, making the image gradually resemble the actual written word.

In an embodiment, the mechanism may include an auditory feedback component that synchronizes with the graphical transformation to reinforce the association between phonemes and graphemes. This component may produce auditory cues for each phoneme as the corresponding part of the word is displayed, further enhancing the child's learning experience. Additionally, the mechanism may store progress data for each learner, allowing the system to dynamically adjust the complexity of future word-to-graphic transformations based on individual learning metrics.

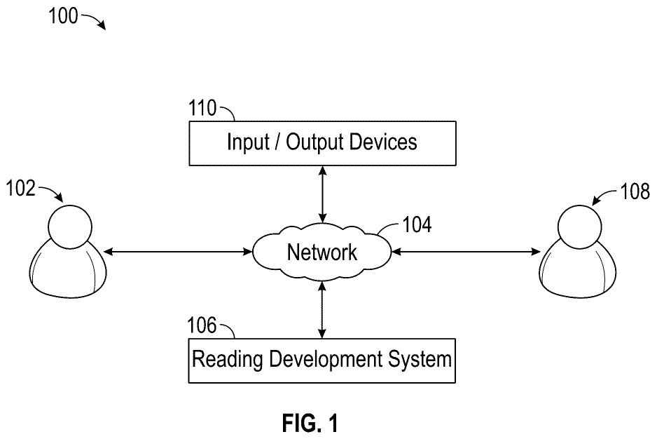

FIG. 1 is an exemplary environment 100 of a system 106 for reading development in children with dyslexia using word-to-graphic transformations, in accordance with an embodiment of the present disclosure. In an embodiment, the exemplary environment 100 may include a learner 102, a teacher or facilitator 108, a network 104, various input/output devices 110, and the reading development system 106 (hereinafter termed as system 106). In an embodiment, the system 106 may be implemented on a server that may include a cloud-based architecture. The interconnected environment 100 may facilitate seamless learning interactions while allowing the teacher 108 to monitor and guide progress of the learner 102. The system 106 may manage word-to-graphic transformations, learner progress tracking, and dynamic complexity adjustments. In an embodiment, all data communication within the environment 100 may occur over a secure network 104 that connects the system 106 to the learner 102, teacher 108, and input/output devices 110.

In an embodiment, the communication network 104 may include, without limitation, a direct interconnection, a Local Area Network (LAN), a Wide Area Network (WAN), a wireless network, the Internet, or any other suitable communication infrastructure.

For the purpose of this disclosure, the learner 102 may correspond to a child using the system 106 to improve their reading skills. The teacher 108 may correspond to an instructor or parent who facilitates the learning process by setting up lessons, monitoring progress, and adjusting difficulty levels as needed. The input/output devices 110 may act as interaction points where the graphical transformations and auditory cues are presented to the learner 102. Further, the system 106 may track learner progress and adjust the learning pathway dynamically, thereby providing customized learning experiences for each child.

In operation, the learner 102 may interact with the system 106 by engaging with a series of word-based activities. When a word is presented, the system 106 may transform the word into a corresponding graphical representation, allowing the learner 102 to understand the word's meaning visually. As the learner's reading proficiency improves, the system 106 may gradually reduce the complexity of the graphical representation, helping the learner transition from reliance on visual aids to recognizing the standard written word. The system 106 may store detailed data about the learner's progress and adjust future learning sessions based on this data.

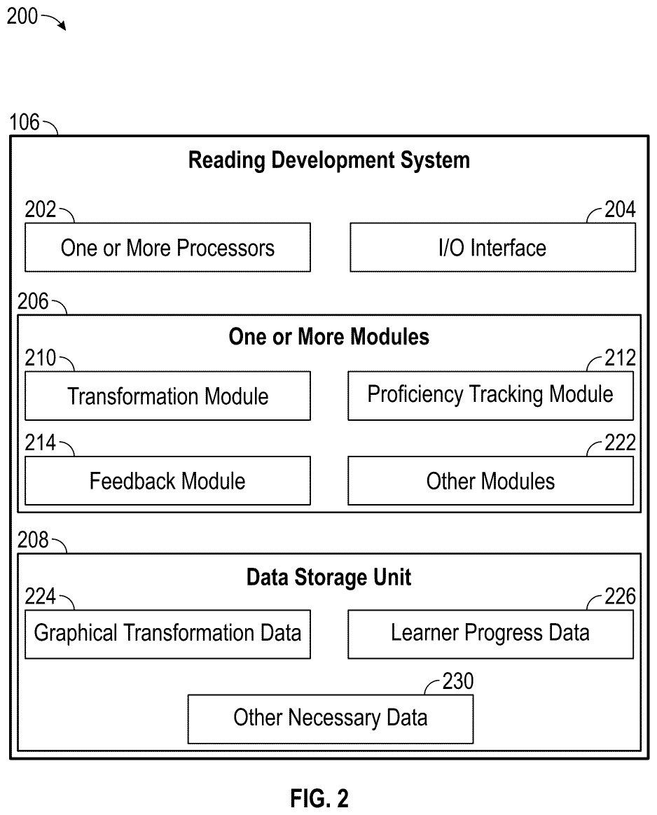

FIG. 2 illustrates a block diagram 200 of system 106 for reading development in children with dyslexia using word-to-graphic transformations, in accordance with an embodiment of the present disclosure. In an embodiment, the system 106 may include one or more processors 202, an Input/Output (I/O) interface 204, one or more modules 206, and a data storage unit 208. The one or more processors 202 may be implemented as one or more microprocessors, digital signal processors, central processing units (CPUs), or other computing devices. The processors 202 may execute instructions for the operation of the system 106, including the management and coordination of the various modules and interfaces. The processors 202 may further be configured to manipulate signals and data based on operational instructions stored in the data storage unit 208 or other connected memory units.

The I/O interface 204 may facilitate communication between the system 106 and external devices, allowing data exchange between the system 106 and users, including learners and facilitators. The I/O interface 204 may include, but is not limited to, components such as touchscreens, keyboards, or network interfaces that enable interaction with the system. In some embodiments, the I/O interface 204 may support wireless communication technologies, including Wi-Fi or Bluetooth, to connect external devices, such as tablets or computers, to the system 106.

The system 106 may further include one or more modules 206 that are responsible for the execution of specific tasks within the system. These modules may include a transformation module 210, a proficiency tracking module 212, a feedback module 214, and any other modules 222 essential for the system's functionality. Each module may be a software or hardware component that operates based on instructions provided by the processor 202. The data storage unit 208 may store various types of data required for the system's operation. This data may include graphical transformation data 224, learner progress data 226, and any other data 230 necessary for the effective functioning of the system.

In alternative embodiments, the system 106 may be implemented in a distributed manner, where the one or more processors 202, I/O interface 204, and data storage unit 208 are located on separate devices and connected via a network. In such embodiments, the I/O interface 204 may enable communication between devices located in different geographical locations, allowing for remote access to the system. Additionally, the data storage unit 208 may be implemented using cloud-based storage solutions, allowing data to be accessed and managed remotely.

In an embodiment, the transformation module 210 may be configured for converting words into graphical representations based on the meaning of the word. The transformation may involve creating an image or graphical structure that visually represents the word, allowing learners to make connections between the written form of the word and its corresponding visual meaning. The transformation module 210 may operate by breaking down the word into its constituent letters or phonemes and mapping these elements onto corresponding visual components of the graphical representation. For example, the word “cat” may be represented as a graphical image of a cat, with each letter forming part of the image.

The transformation module 210 may also manage the progressive reduction of the graphical complexity of the representation as the learner's reading proficiency improves. As the learner becomes more familiar with the word and its phonetic components, the transformation module 210 may simplify the image, gradually transitioning the learner from reliance on the graphical representation to recognition of the standard written word. This progressive reduction may be implemented through various stages, where the visual representation becomes less detailed over time.

In alternative embodiments, the transformation module 210 may be configured to adapt to different learning styles or preferences. For example, in some cases, the graphical representations may be more abstract, using simplified icons or symbols to represent words. In other embodiments, the graphical transformations may incorporate animated elements that provide dynamic visual cues to support the learner's understanding of the word. The transformation module 210 may also include settings for customizing the pace of graphical simplification based on individual learner progress, allowing for a more personalized learning experience.

In an embodiment, the proficiency tracking module 212 may be configured for monitoring and recording the learner's progress over time. The proficiency tracking module 212 may collect data regarding the learner's interactions with the graphical transformations, including the accuracy and speed with which the learner recognizes and decodes words. The data collected by the proficiency tracking module 212 may be stored in the learner progress data 226, which may include detailed records of each learner's performance across multiple learning sessions.

The proficiency tracking module 212 may use this data to dynamically adjust the complexity of future graphical transformations. For example, if the data indicates that a learner consistently recognizes a particular word, the proficiency tracking module 212 may instruct the transformation module 210 to simplify the graphical representation of that word, gradually transitioning the learner towards reading the word in its standard written form. Conversely, if the data shows that the learner is struggling with a specific word, the system may maintain or even increase the complexity of the graphical representation to provide additional support.

In alternative embodiments, the proficiency tracking module 212 may be integrated with external assessment tools or educational platforms, allowing teachers or facilitators to review and analyze the learner's progress. The proficiency tracking module 212 may also generate reports or visual representations of the learner's progress, providing a comprehensive view of the learner's development over time. In some cases, the proficiency tracking module 212 may be configured to set specific learning goals for each learner, adjusting the learning pathway based on predefined criteria or educator input.

It should be understood that the specific implementation of the proficiency tracking module 212 may vary depending on the requirements of the learning environment. In some embodiments, the tracking module 212 may operate autonomously, while in others, it may require input or oversight from an educator. The system 106 may also include safeguards to ensure the accuracy and integrity of the data collected by the proficiency tracking module 212, such as data validation protocols or error-checking mechanisms.

In an embodiment, the feedback module 214 may be configured for providing real-time auditory and visual feedback to the learner during the learning process. The feedback module 214 may be integrated with the transformation module 210 and proficiency tracking module 212 to ensure that feedback is contextually relevant and based on the learner's current progress. For example, the feedback module 214 may provide positive reinforcement when a learner correctly identifies a word or offer guidance when the learner encounters difficulties. Feedback may be delivered through visual cues, sound effects, or verbal prompts, depending on the preferences of the learner and the specific learning environment.

In alternative embodiments, the feedback module 214 may offer customizable feedback settings, allowing educators or learners to choose the type and frequency of feedback provided. The feedback module 214 may also be configured to support multiple languages, making the system 106 adaptable to various educational contexts.

It should be noted that the specific features and functionalities described for the transformation module 210, proficiency tracking module 212, and feedback module 214 are provided for illustrative purposes and are not intended to limit the scope of the invention. Various modifications and alternative embodiments may be implemented without departing from the principles and scope of the invention.

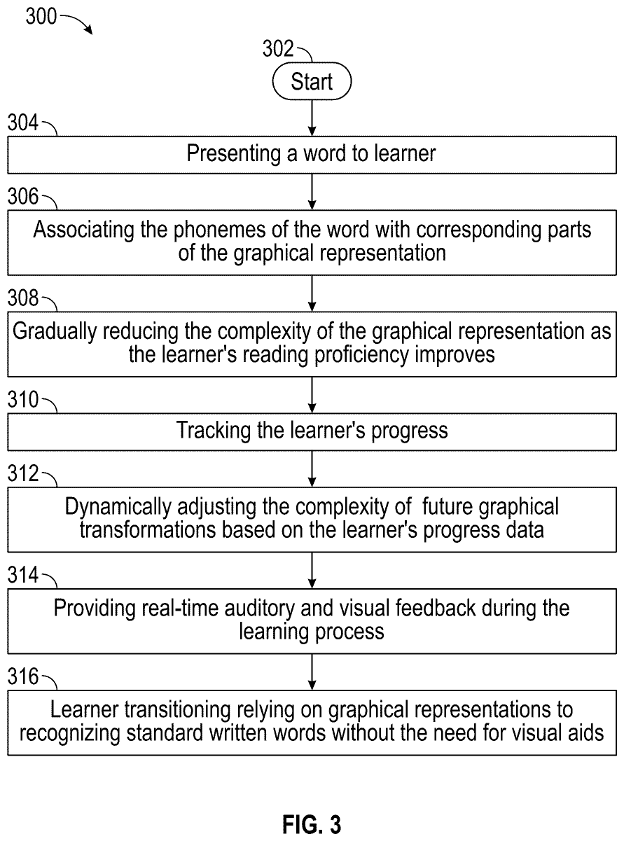

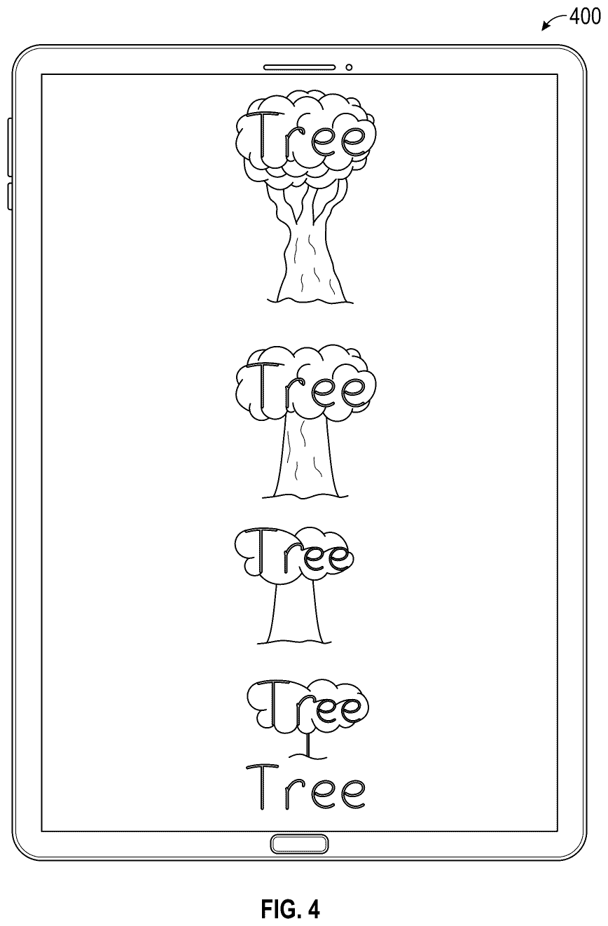

FIG. 3 is a flowchart 300 illustrating a method for reading development in children with dyslexia using word-to-graphic transformations, in accordance with an embodiment of the present disclosure. The method may start at step 302.

At first, the method may include the step of presenting a word to the learner, at step 304. The word may be transformed into a corresponding graphical representation that visually represents the meaning of the word. For example, the word “cat” may be transformed into an image of a cat, where each letter in the word is represented as part of the image. In one implementation, the transformation module 210 within system 106 may perform this step.

Next, at step 306, the method may include the step of associating the phonemes of the word with corresponding parts of the graphical representation. The graphical transformation may help the learner understand the connection between each sound and its corresponding letter in the word. In one implementation, this step may also be carried out by the transformation module 210.

At step 308, the method may include the step of gradually reducing the complexity of the graphical representation as the learner's reading proficiency improves. As the learner becomes more familiar with the word, the graphical representation may be simplified to resemble the standard written word. In one implementation, the transformation module 210, under the control of the proficiency tracking module 212, may execute this step.

Next, at step 310, the method may include the step of tracking the learner's progress using the proficiency tracking module 212. The learner's interactions with the graphical transformations, including accuracy and speed of word recognition, may be recorded and stored in the learner progress data 226 in the data storage unit 208.

At step 312, the method may include the step of dynamically adjusting the complexity of future graphical transformations based on the learner's progress data. If the learner demonstrates proficiency in recognizing a word, the graphical complexity may be reduced further in subsequent lessons. If the learner struggles with a word, the graphical representation may remain detailed or increase in complexity to provide additional support. This step may be controlled by the proficiency tracking module 212, which interacts with the transformation module 210 and the data storage unit 208.

Next, at step 314, the method may include the step of providing real-time auditory and visual feedback during the learning process. The system may provide cues, sound effects, or visual prompts to reinforce the learner's understanding of the word and its phonetic components. The feedback module 214 may be responsible for generating and delivering this feedback.

At step 316, the method may end with the learner transitioning from relying on graphical representations to recognizing standard written words without the need for visual aids. This final transition may be managed by the combined efforts of the transformation module 210, proficiency tracking module 212, and feedback module 214, as directed by the processor 202.

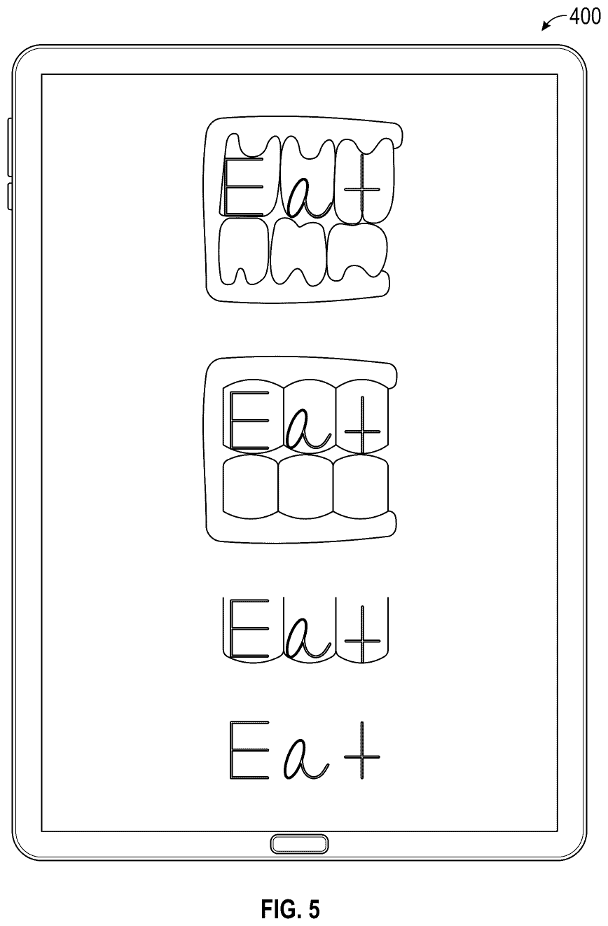

FIG. 4 illustrates an application of the system 106 and method 300 for reading development in children with dyslexia using word-to-graphic transformations, in accordance with an embodiment of the present disclosure. In this embodiment, the learner interacts with the mechanism (which includes system 106 and method 300) through a tablet device 400, where all the visual information is presented. The transformation module 210 of the system 106 is configured to convert the word “Tree” into a detailed graphical image where each letter forms part of the tree graphic. As shown in FIG. 4, the transformation begins with a fully detailed image at the top, where the letters are integrated into the graphic. As the learner progresses, the proficiency tracking module 212 monitors the learner's ability to recognize and decode the word, adjusting the complexity of the transformation accordingly. As the learner's reading proficiency improves, the graphical representation is simplified in stages, as depicted in the lower sections of FIG. 4, eventually transitioning to the standard written form of the word “Tree.”

The proficiency tracking module 212 ensures that this progression is tailored to the learner's individual pace by dynamically adjusting the transformation based on performance data. If the learner demonstrates sufficient proficiency at one stage, the system advances to a simpler graphical representation. Throughout this process, the feedback module 214 provides real-time auditory and visual feedback to reinforce learning. For each stage of the transformation, auditory cues corresponding to the phonemes of the word may be provided, helping the learner connect the visual and phonetic aspects of the word. Visual feedback, such as highlighting parts of the graphic or offering success indicators, ensures that the learner remains engaged and supported. In this way, the mechanism facilitates a smooth transition from relying on visual representations to recognizing the standard written form of words, as demonstrated in FIG. 4. All of this information is viewed by the learner on the tablet device 400, which acts as the interface for displaying the graphical transformations and interactive feedback. It should be noted that tablet device 400 is only one example of smart device and can be substituted by any other smart device including, but not limited to, a smartphone, a laptop, a computer, and the like.

FIG. 5 illustrates an application of the system 106 and method 300 for reading development in children with dyslexia using word-to-graphic transformations, in accordance with an embodiment of the present disclosure. In this embodiment, the learner interacts with the mechanism (which includes system 106 and method 300) through a tablet device 400, where all the visual information is presented. The transformation module 210 of the system 106 is configured to convert the word “Eat” into a detailed graphical image where each letter forms part of the mouth graphic showing teeth. As shown in FIG. 5, the transformation begins with a fully detailed image at the top, where the letters are integrated into the graphic. As the learner progresses, the proficiency tracking module 212 monitors the learner's ability to recognize and decode the word, adjusting the complexity of the transformation accordingly. As the learner's reading proficiency improves, the graphical representation is simplified in stages, as depicted in the lower sections of FIG. 5, eventually transitioning to the standard written form of the word “Eat.”

FIG. 6 illustrates an application of the system 106 and method 300 for reading development in children with dyslexia using word-to-graphic transformations, in accordance with an embodiment of the present disclosure. In this embodiment, the learner interacts with the mechanism (which includes system 106 and method 300) through a tablet device 400, where all the visual information is presented. The transformation module 210 of the system 106 is configured to convert the word “Car” into a detailed graphical image where each letter forms part of the tree graphic. As shown in FIG. 6, the transformation begins with a fully detailed image at the top, where the letters are integrated into the graphic. As the learner progresses, the proficiency tracking module 212 monitors the learner's ability to recognize and decode the word, adjusting the complexity of the transformation accordingly. As the learner's reading proficiency improves, the graphical representation is simplified in stages, as depicted in the lower sections of FIG. 6, eventually transitioning to the standard written form of the word “Car.”

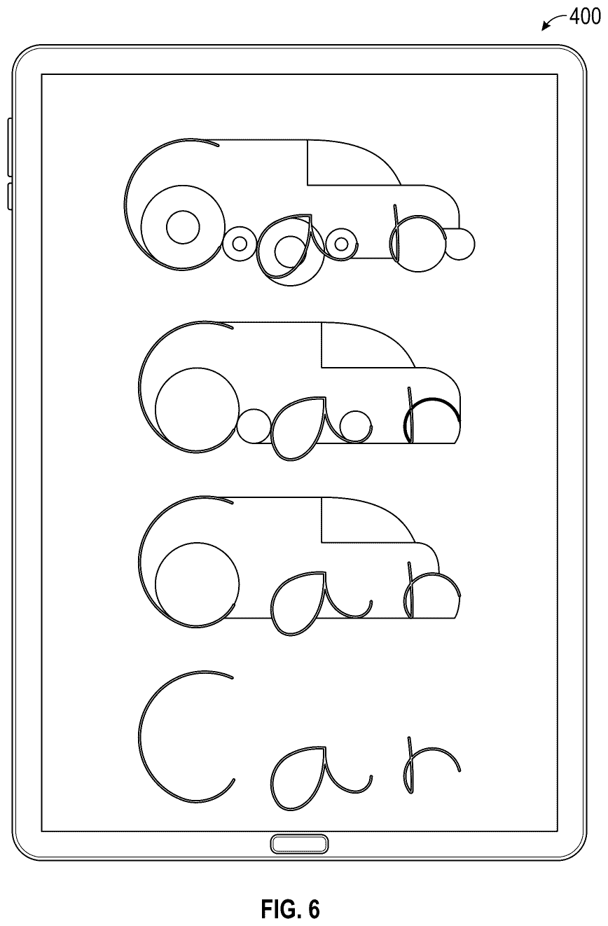

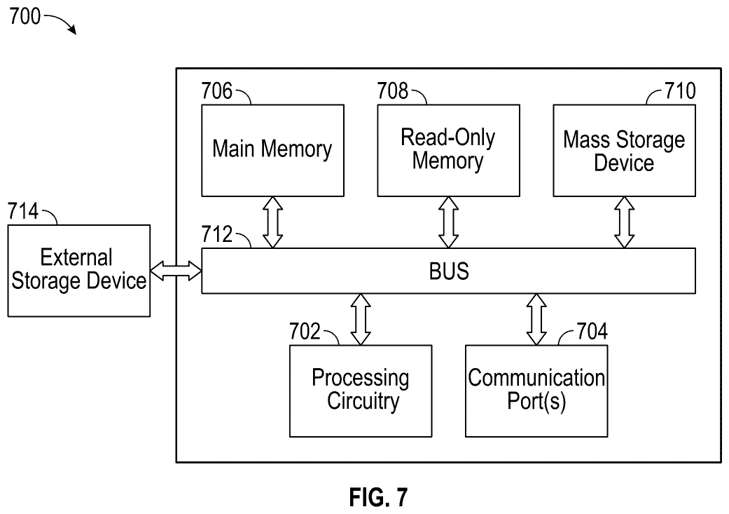

FIG. 7 is an exemplary computer unit 700 in which or with which embodiments of the present disclosure may be utilized. Depending upon the implementation, the various process and decision blocks described above may be performed by hardware components, embodied in machine-executable instructions, which may be used to cause a general-purpose or special-purpose processor programmed with the instructions to perform the steps, or the steps may be performed by a combination of hardware, software and/or firmware. As shown in FIG. 7, the computer system 700 includes an external storage device 714, a bus 712, a main memory 706, a read-only memory 708, a mass storage device 710, a communication port(s) 704, and a processing circuitry 702.

Those skilled in the art will appreciate that the computer system 700 may include more than one processing circuitry 702 and one or more communication ports 704. The processing circuitry 702 should be understood to mean circuitry based on one or more microprocessors, microcontrollers, digital signal processors, programmable logic devices, Field-Programmable Gate Arrays (FPGAs), Application-Specific Integrated Circuits (ASICs), etc., and may include a multi-core processor (e.g., dual-core, quad-core, Hexa-core, or any suitable number of cores) or supercomputer. In some embodiments, the processing circuitry 702 is distributed across multiple separate processors or processing units, for example, multiple of the same type of processing units (e.g., two Intel Core i7 processors) or multiple different processors (e.g., an Intel Core i5 processor and an Intel Core i7 processor). Examples of the processing circuitry 702 include, but are not limited to, an Intel® Itanium® or Itanium 2 processor(s), AMD® Opteron® or Athlon MP® processor(s), Motorola® lines of processors, System on Chip (SoC) processors, or other future processors. The processing circuitry 702 may include various modules associated with embodiments of the present disclosure.

The communication port 704 may include a cable modem, Integrated Services Digital Network (ISDN) modem, a Digital Subscriber Line (DSL) modem, a telephone modem, an Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of electronic devices or communication of electronic devices in locations remote from each other. The communication port 704 may be any RS-232 port for use with a modem-based dialup connection, a 10/100 Ethernet port, a Gigabit, or a 10 Gigabit port using copper or fiber, a serial port, a parallel port, or other existing or future ports. The communication port 704 may be chosen depending on a network, such as a Local Area Network (LAN), Wide Area Network (WAN), or any network to which the computer system 700 may be connected.

The main memory 706 may include Random Access Memory (RAM) or any other dynamic storage device commonly known in the art. Read-only memory (ROM) 708 may be any static storage device(s), e.g., but not limited to, a Programmable Read-Only Memory (PROM) chips for storing static information, e.g., start-up or BIOS instructions for the processing circuitry 702.

The mass storage device 710 may be an electronic storage device. As referred to herein, the phrase “electronic storage device” or “storage device” should be understood to mean any device for storing electronic data, computer software, or firmware, such as random-access memory, read-only memory, hard drives, optical drives, Digital Video Disc (DVD) recorders, Compact Disc (CD) recorders, BLU-RAY disc (BD) recorders, BLU-RAY 3D disc recorders, Digital Video Recorders (DVRs, sometimes called a personal video recorder or PVRs), solid-state devices, quantum storage devices, gaming consoles, gaming media, or any other suitable fixed or removable storage devices, and/or any combination of the same. Nonvolatile memory may also be used (e.g., to launch a boot-up routine and other instructions). Cloud-based storage may be used to supplement the main memory 706. The mass storage device 710 may be any current or future mass storage solution, which may be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firmware interfaces), e.g., those available from Seagate (e.g., the Seagate Barracuda 7200 family) or Hitachi (e.g., the Hitachi Deskstar 7K1000), one or more optical discs, Redundant Array of Independent Disks (RAID) storage, e.g., an array of disks (e.g., SATA arrays), available from various vendors including Dot Hill Systems Corp., LaCie, Nexsan Technologies, Inc. and Enhance Technology, Inc.

The bus 712 communicatively couples the processing circuitry 702 with the other memory, storage, and communication blocks. The bus 712 may be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processing circuitry 702 to the software system.

Optionally, operator and administrative interfaces, e.g., a display, keyboard, and a cursor control device, may also be coupled to the bus 712 to support direct operator interaction with the computer system 700. Other operator and administrative interfaces may be provided through network connections connected through the communication port(s) 704. The external storage device 714 may be any kind of external hard drives, floppy drives, IOMEGA® Zip Drive, Compact Disc-Read-Only Memory (CD-ROM), Compact Disc-Re-Writable (CD-RW), Digital Video Disk Read Only Memory (DVD-ROM). The components described above are meant only to exemplify various possibilities. In no way should the aforementioned exemplary computer system limit the scope of the present disclosure.

The computer system 700 may be accessed through a user interface. The user interface application may be implemented using any suitable architecture. For example, it may be a stand-alone application wholly implemented on the computer system 700. The user interfaces application and/or any instructions for performing any of the embodiments discussed herein may be encoded on computer-readable media. Computer-readable media includes any media capable of storing data. In some embodiments, the user interface application is client-server-based. Data for use by a thick or thin client implemented on an electronic device computer system 700 is retrieved on-demand by issuing requests to a server remote to the computer system 700. For example, computer system 700 may receive inputs from the user via an input interface and transmit those inputs to the remote server for processing and generating the corresponding outputs. The generated output is then transmitted to the computer system 700 for presentation to the user.

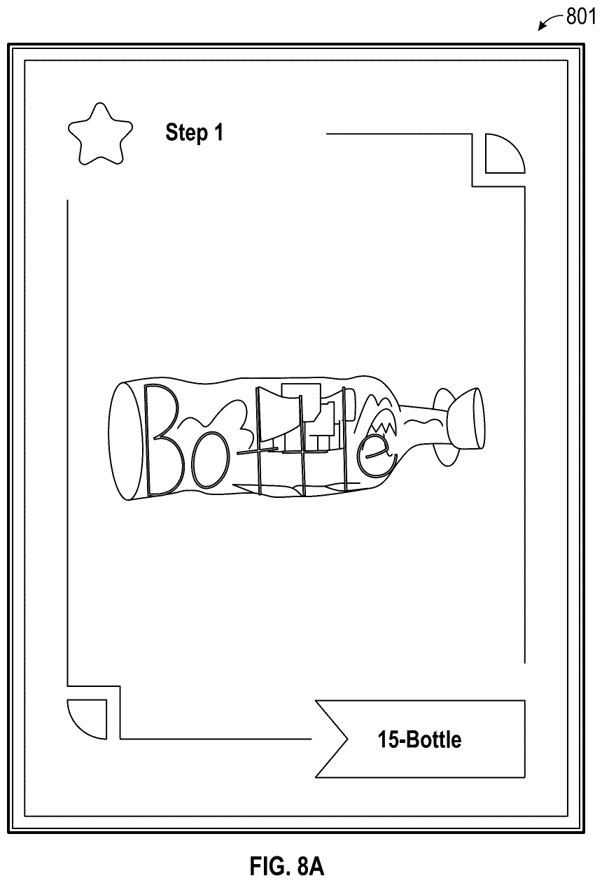

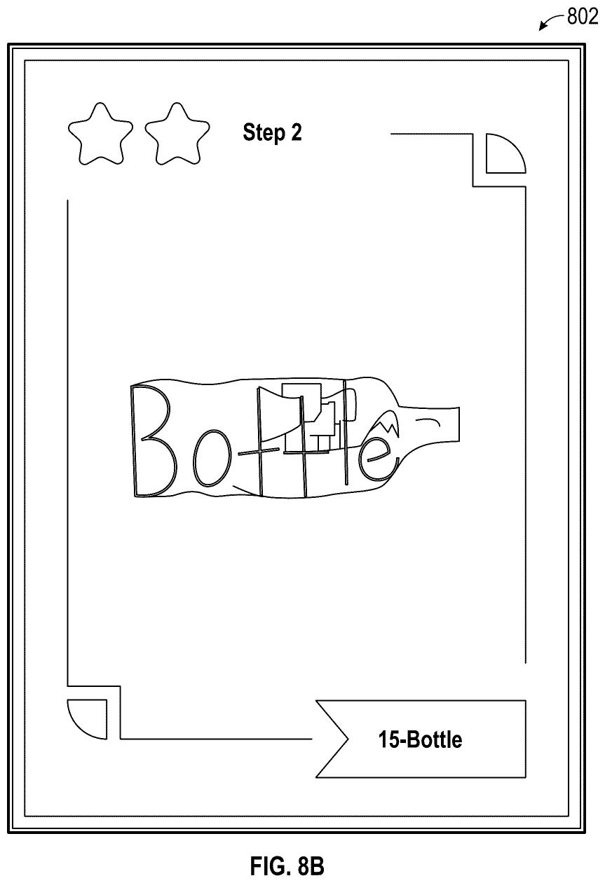

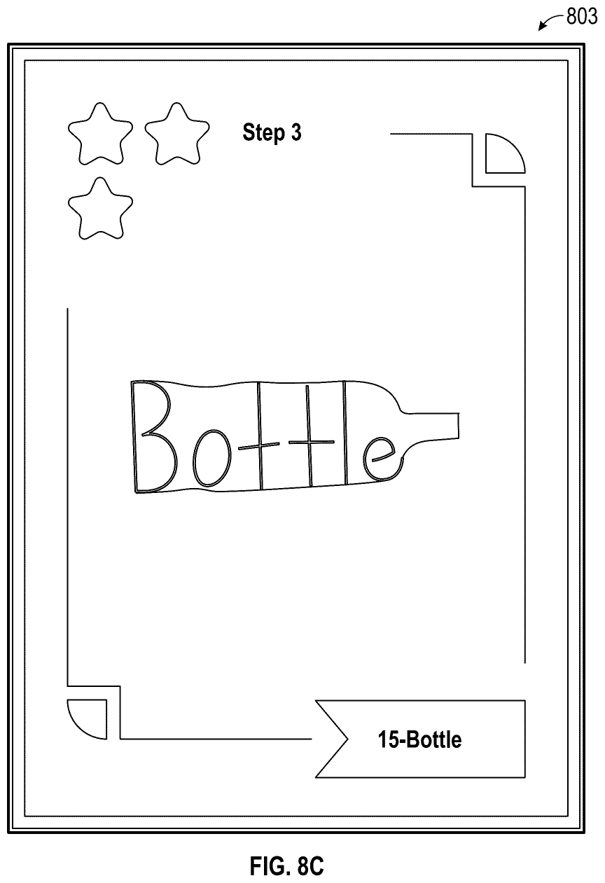

FIGS. 8A, 8B, and 8C illustrate first-stage, second-stage, and third-stage physical flashcards for the word “Bottle,” in accordance with an embodiment of the present disclosure. FIG. 8A illustrates a first physical flashcard 801 in a three-stage series for the word “Bottle.” At this initial level of graphical complexity, the letters of the word are visually embedded within a highly detailed pictorial representation of a bottle. The graphic seamlessly integrates the letterforms into the image, ensuring that the learner can intuitively associate the word “Bottle” with its meaning. This first flashcard provides maximum visual reinforcement by closely resembling the object it represents. By linking the orthographic structure of the word to a concrete image, children with dyslexia can leverage visual-spatial reasoning to develop word recognition skills while forming a strong association between the written word and its conceptual meaning.

FIG. 8B depicts a second physical flashcard 802, which offers an intermediate graphical representation of the word “Bottle.” In this stage, the detailed depiction of the bottle is simplified, making the letterforms more distinguishable while still maintaining an identifiable connection to the original image. The learner is encouraged to manipulate this second flashcard after the first, gradually shifting their reliance from purely pictorial cues to increased textual recognition. This stepwise reduction in visual elements bridges the gap between a fully integrated graphic and a more text-centric form.

FIG. 8C represents a third physical flashcard 803 for the word “Bottle,” where the graphical elements are further minimized to highlight primarily the textual representation of the word. Any remaining visual cues are subtle. By this advanced stage, the learner is expected to recognize and read “Bottle” with minimal pictorial support. This transition from a highly integrated illustration to a predominantly textual form promotes reading fluency and independent word recognition skills over time.

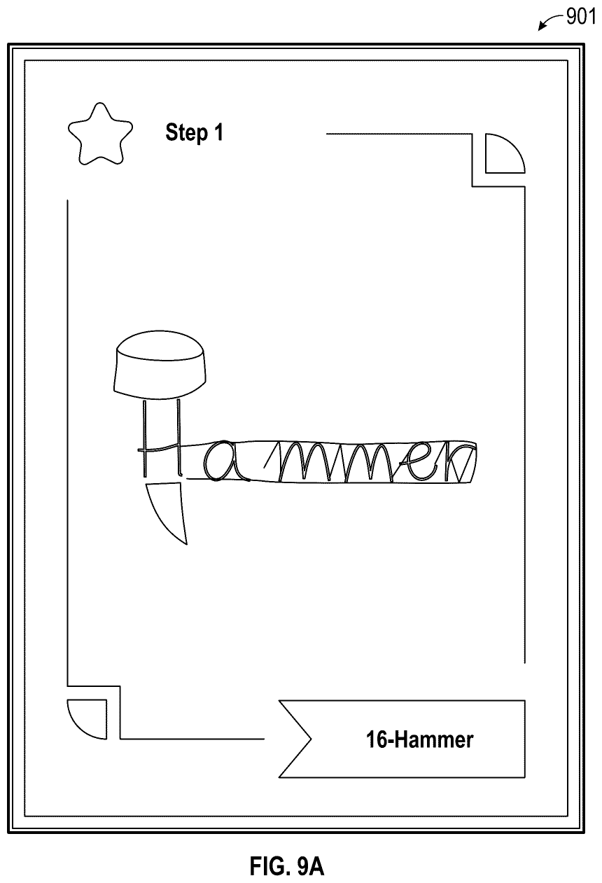

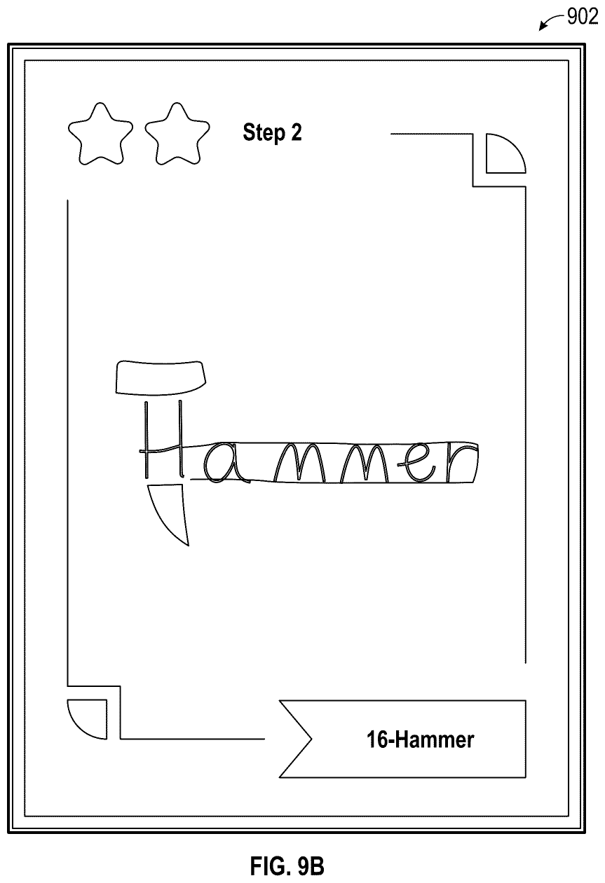

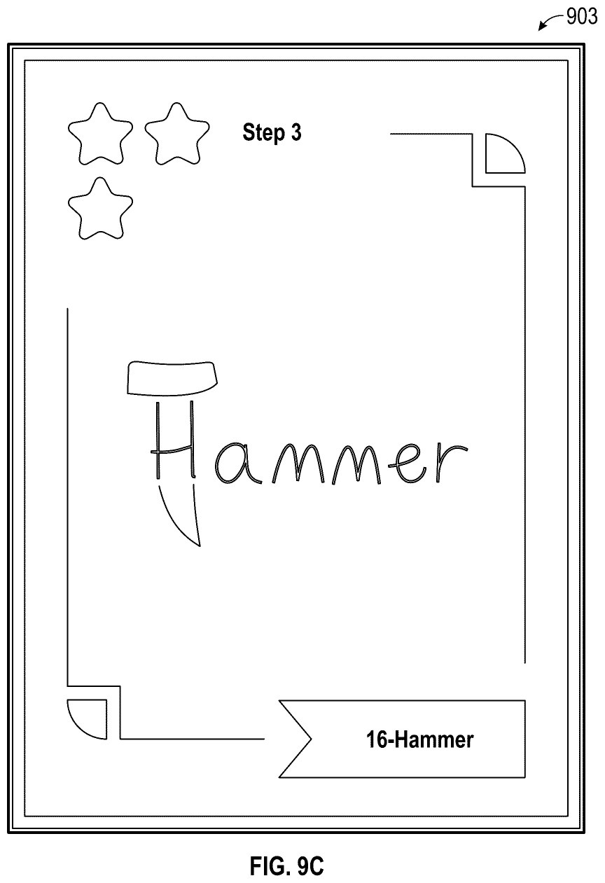

FIGS. 9A, 9B, and 9C illustrate first-stage, second-stage, and third-stage physical flashcards for the word “Hammer,” in accordance with an embodiment of the present disclosure. FIG. 9A illustrates a first physical flashcard 901 for the word “Hammer.” Much like the “Bottle” series, the initial card integrates the word's letters into a detailed image of a hammer, reinforcing the association between the written form and its real-world object. This design capitalizes on visual integration to support dyslexic learners by associating each phoneme with a pictorial element. The hammer illustration provides contextual meaning, enabling learners to link the word's letterforms directly to the concept or object it represents.

FIG. 9B depicts a second physical flashcard 902, presenting an intermediate level of complexity for “Hammer.” While certain structural aspects of the hammer image remain, some details have been removed, making the embedded letters more apparent. This phase aims to reduce visual reliance while preserving enough imagery for continued word association. Learners begin to focus more on letter shapes and phoneme-grapheme links, paving the way for a smoother shift to predominantly textual recognition.

FIG. 9C shows a third physical flashcard 903, completing the transformation sequence for “Hammer.” Here, the hammer image is further simplified, leaving mostly text and minimal graphical remnants. At this point, the learner is expected to recognize and read “Hammer” without depending heavily on pictorial representation. The structured, incremental removal of visual elements fosters a natural progression from image-supported to independent reading.

Such multiple-flashcard approach offers flexibility in various educational settings. Teachers, therapists, or parents can present the cards in sequential order, guiding learners from the most visually integrated depiction to a largely textual representation at a pace tailored to each learner's proficiency. In certain embodiments, the steps of method 300 for reading development can be executed solely with these physical flashcards, in absence of a digital device. By arranging and manipulating each set of flashcards, learners with dyslexia develop reading skills through a multisensory progression that capitalizes on their ability to form and retain visual-spatial associations. The incremental simplification of each successive card alleviates cognitive load, helping learners build confidence and fluency in reading words independently.

Thus, the present disclosure discloses a system and method for facilitating reading development in children with dyslexia by transforming words into graphical representations. The method and system help children with dyslexia make connections between speech sounds and written letters by leveraging their visual-spatial reasoning abilities. The system operates by progressively simplifying the graphical representations of words as the learner's reading proficiency improves, ultimately bridging the gap between visual aids and recognition of standard written words. The graphical transformation process is accompanied by real-time auditory feedback, which reinforces the association between phonemes and graphemes. This combination of visual and auditory learning techniques enhances the child's overall reading development.

The system tracks each learner's progress through a proficiency tracking module, which records data on how accurately and quickly the learner recognizes words. The system dynamically adjusts the complexity of future word-to-graphic transformations based on this data, ensuring that the learner's individual needs are met. The feedback module provides personalized real-time feedback, both auditory and visual, which guides the learner through the reading process. This feedback includes sound effects, verbal prompts, and visual cues that support the learner's understanding and engagement throughout the learning process.

The system operates on an interactive platform, such as a tablet, allowing children to engage directly with word-to-graphic transformations and receive immediate feedback on their progress. As the learner becomes more proficient, the transformation module simplifies the visual complexity of the word's representation, helping the child transition to recognizing the standard written form. The method and system enable children to gradually move from relying on graphical representations to fluently recognizing written words, providing a seamless and adaptive learning experience.

The adaptive technology used in the system ensures that the learning experience is tailored to each child's pace, enabling effective reading development for children with dyslexia. The system's feedback and tracking modules continuously monitor performance and adjust the learning pathway to meet individual needs. This flexible approach ensures that children receive the necessary support throughout the learning process. The system's design facilitates a smooth transition from visual dependency to textual fluency, promoting long-term reading success for children with dyslexia.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system for facilitating reading development in learners with dyslexia, the system comprising:
a transformation module configured to convert an input word into a graphical representation that visually depicts a meaning of the input word;
a proficiency tracking module configured to collect and store learner performance data, the data comprising accuracy and speed of recognizing words displayed as graphical representations;
a control unit communicatively coupled to the transformation module and the proficiency tracking module, the control unit being configured to:
a. progressively simplify the graphical representation of the input word based on the learner's stored performance data; and
adjust future graphical transformations according to the learner's progress; and
a feedback module configured to provide real-time visual or auditory cues to reinforce phoneme-grapheme associations while a learner engages with the graphical representation.

2. The system of claim 1, wherein the feedback module is configured to highlight a portion of the graphical representation in synchronization with an auditory output corresponding to one or more phonemes of the word.

3. The system of claim 1, further comprising a data storage unit that stores:
graphical transformation data defining how each word is converted into one or more stages of graphical representation; and
learner progress data tracking each learner's historical performance over multiple sessions.

4. The system of claim 1, wherein the transformation module is further configured to present a partially simplified version of the graphical representation after the learner achieves a predetermined accuracy threshold for the word.

5. The system of claim 1, wherein the control unit is implemented on a cloud-based server, and a learner interacts with the transformation module via a client device selected from the group consisting of a tablet, a smartphone, or a personal computer.

6. The system of claim 1, wherein the feedback module is configured to generate animations corresponding to each phoneme, thereby visually accentuating transitions between different parts of the graphical representation.

7. The system of claim 1, wherein the proficiency tracking module is configured to rank the difficulty of words based on learner performance data and to recommend individualized word sets for subsequent practice sessions.

8. A method for reading development in learners with dyslexia, the method comprising:
presenting a word to a learner;
associating the phonemes of the word with corresponding parts of a graphical representation;
gradually reducing the complexity of the graphical representation as the learner's reading proficiency improves;
tracking the learner's progress;
dynamically adjusting the complexity of future graphical transformations based on the learner's progress data;
providing real-time auditory and visual feedback during the learning process; and
transitioning from reliance on graphical representations to recognizing standard written words without the need for visual aids.

9. The method of claim 8, wherein presenting the word to the learner comprises displaying the word and an initial graphical representation on a digital interface accessible to the learner.

10. The method of claim 8, wherein associating the phonemes of the word with corresponding parts of the graphical representation includes generating auditory cues for each phoneme.

11. The method of claim 8, wherein gradually reducing the complexity of the graphical representation comprises removing selected visual elements while retaining at least one letter shape indicative of the original graphical outline.

12. The method of claim 8, wherein tracking the learner's progress includes recording the learner's accuracy and speed for recognizing each transformed word.

13. The method of claim 8, wherein providing real-time auditory and visual feedback comprises highlighting portions of the graphical representation in synchronization with an audio output corresponding to one or more phonemes.

14. The method of claim 8, further comprising:
providing a plurality of physical flashcards, each flashcard depicting the word at a different level of graphical complexity, including a first flashcard that integrates the word into a corresponding object and subsequent flashcards that remove additional visual elements; and
instructing the learner to arrange or manipulate the flashcards in a sequence from the most visually integrated depiction to a more simplified depiction of the word, thereby reinforcing phoneme-grapheme associations through progressively reduced difficulty.
